(19) United States
(12) Patent Application Publication
(10) Pub. No.: US 2007/0190357 A1
(43) Pub. Date: Aug. 16, 2007

(54) Electroluminescent materials and devices

(76) Inventors: Poopathy Kathirga- Manathan, Middlesex (GB); Richard Price, Lancashire (GB); Selvadurai Selvaranjan, Raynes Park (GB)

Correspondence Address: David Silverstein;Andover-IP- Law, 44 Park Street, Suite 300, Andover, MA, 01810, US

(21) Appl. No.: 11/630,765

(22) PCT Filed: Jun. 30, 2005
(86) PCT No.: PCT/GB05/02579

§ 371 Date: Dec. 22, 2006

(30) Foreign Application Priority Data
Jun. 30, 2004 (GB) 0414639.5

(51) Int. Cl. B32B 19/00

(52) U.S. Cl. 428/690

(57) ABSTRACT

An electroluminescent material useful in OLEDS is a metal thioxinate.

The present invention relates to electroluminescent materials and to electroluminescent devices.

Materials which emit light when an electric current is passed through them are well known and are used in a wide range of display applications. Liquid crystal devices and devices which are based on inorganic semiconductor systems are widely used; however these suffer from the disadvantages of high energy consumption, high cost of manufacture, low quantum efficiency and the inability to make flat panel displays.

In a typical electroluminescent device (sometimes referred to as an organic light emitting device or OLED) the electroluminescent material is between a transparent electrode of high work function and a second electrode of low work function with a hole conducting layer interposed between the electroluminescent layer and the transparent high work function electrode and an electron conducting layer interposed between the electroluminescent layer and the electron injecting low work function cathode. The hole conducting layer and the electron conducting layer are required to improve the working and efficiency of the device. The hole transporting layer serves to transport holes and to block the electrons, thus preventing electrons from moving into the electrode without recombining with holes. The recombination of carriers therefore mainly takes place in the emitter layer.

Organic polymers have been proposed as useful in electroluminescent devices, but it is not possible to obtain pure colours; they are expensive to make and have a relatively low efficiency.

Another compound which has been proposed is aluminium quinolate, but this requires dopants to be used to obtain a range of colours and has a relatively low efficiency. There are a large number of patents based on the use of aluminium quinolates in electroluminescent devices. Patents U.S. Pat. No. 4,720,432; U.S. Pat. No. 5,141,671; U.S. Pat. No. 5,755,999 and patent applications WO99/53724 and JP 06145146 disclose a number of quinolates and quinoline derivatives which have been used as electroluminescent materials and refer to other electroluminescent materials and patents therefore.

Hitherto these electroluminescent materials based on metal salts or organo metallic complexes have used light metals such as aluminium or metals such as lanthanides, actinides, rare earths or transition metals as the metal.

Although quinolates have been proposed as electroluminescent materials the thioxinates have not been proposed; one reason for this is that the thioxinates of metals previously proposed are not able to be synthesised as a suitable complex.

We have now found that there are metal thioxinates which can be used as electroluminescent materials.

According to the invention there is provided an electroluminescent device which comprises (i) a first electrode (ii) a layer of an electroluminescent material of formula (I) below and (iii) a second electrode.

The thioxinates which can be used in the present invention are of formula 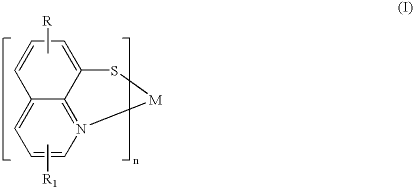
where M is a metal selected from zinc, cadmium, gallium and indium; n is the valency of M; R and R₁ which can be the same or different are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; substituted and unsubstituted hydrocarbyl groups such as substituted and unsubstituted aliphatic groups, substituted and unsubstituted aliphatic groups.

Mercury could be used but is not suitable for environmental reasons.

The thioxinate salt can be prepared by the reaction of a salt of the metal with 8-quinolinethiol, preferably in the form of a salt such as 8-quinolinethiol hydrochloride according to the reaction scheme 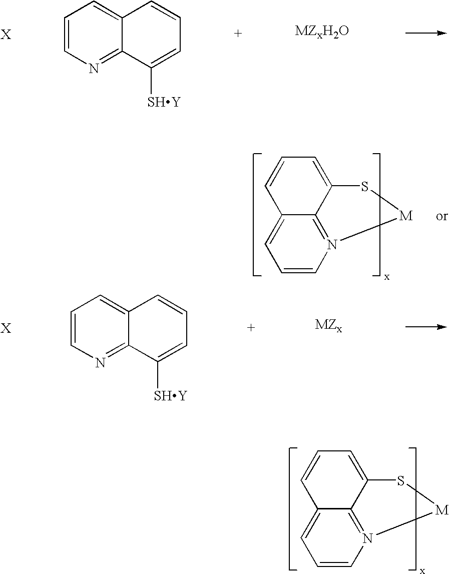
where M is the metal, x is the valency of a metal, Y is an acid, preferably HCL and Z is a monovalent anion. If Z is divalent or trivalent then the value of X is adjusted accordingly e.g. if Z and M are divalent then a salt MZ or MZH₂O is used. Preferably the reaction takes place in a solvent such as ethanol.

The preferred metals M are lithium, sodium, potassium, rubidium, caesium, beryllium, magnesium, calcium, strontium, barium, copper, silver, gold, zinc, cadmium, boron, aluminium, gallium, indium, germanium, tin (II), tin (IV), antimony (II), antimony (IV), lead (II), lead (IV) and metals of the first, second and third groups of transition metals in different valence states e.g. manganese, iron, ruthenium, osmium, cobalt, nickel, palladium(II), palladium(IV), platinum(II), platinum(IV), cadmium, chromium. titanium, vanadium, zirconium, tantalum, molybdenum, rhodium, iridium, titanium, niobium, scandium and yttrium.

The first electrode can function as the anode and the second electrode can function as the cathode and preferably there is a layer of a hole transporting material between the anode and the layer of the electroluminescent compound.

The hole transporting material can be any of the hole transporting materials used in electroluminescent devices.

The hole transporting material can be an amine complex such as poly (vinylcarbazole), N,N′-diphenyl-N,N′-bis(3-methylphenyl)-1,1′-biphenyl-4,4′-diamine (TPD), an unsubstituted or substituted polymer of an amino substituted aromatic compound, a polyaniline, substituted polyanilines, polythiophenes, substituted polythiophenes, polysilanes etc. Examples of polyanilines are polymers of

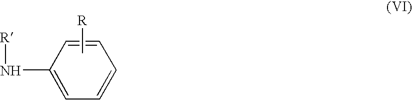

where R is in the ortho- or meta-position and is hydrogen, C1-18 alkyl, C1-6 alkoxy, amino, chloro, bromo, hydroxy or the group 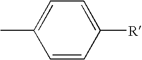
where R is alky or aryl and R′ is hydrogen, C1-6 alkyl or aryl with at least one other monomer of formula (VI) above.

Or the hole transporting material can be a polyaniline; polyanilines which can be used in the present invention have the general formula

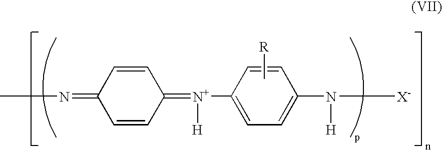

where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulose sulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate; an example of an arenedicarboxylate is phthalate and an example of arenecarboxylate is benzoate.

We have found that protonated polymers of the unsubstituted or substituted polymer of an amino substituted aromatic compound such as a polyaniline are difficult to evaporate or cannot be evaporated. However we have surprisingly found that if the unsubstituted or substituted polymer of an amino substituted aromatic compound is deprotonated, then it can be easily evaporated, i.e. the polymer is evaporable.

Preferably evaporable deprotonated polymers of unsubstituted or substituted polymer of an amino substituted aromatic compound are used. The de-protonated unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and de-protonating. Methods of preparing polyanilines are described in the article by A. G. MacDiarmid and A. F. Epstein, Faraday Discussions, Chem Soc. 88 P319 1989.

The conductivity of the polyaniline is dependent on the degree of protonation with the maximum conductivity being when the degree of protonation is between 40 and 60%, for example, about 50%.

Preferably the polymer is substantially fully deprotonated.

A polyaniline can be formed of octamer units. i.e. p is four, e.g.

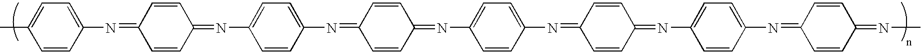

The polyanilines can have conductivities of the order of 1×10⁻¹ Siemen cm⁻¹ or higher.

The aromatic rings can be unsubstituted or substituted, e.g. by a Cl to 20 alkyl group such as ethyl.

The polyaniline can be a copolymer of aniline and preferred copolymers are the copolymers of aniline with o-anisidine, m-sulphanilic acid or o-aminophenol, or o-toluidine with o-aminophenol, o-ethylaniline, o-phenylene diamine or with amino anthracenes.

Other polymers of an amino substituted aromatic compound which can be used include substituted or unsubstituted polyaminonapthalenes, polyaminoanthracenes, polyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted, e.g. by a group R as defined above.

Other hole transporting materials are conjugated polymer and the conjugated polymers which can be used can be any of the conjugated polymers disclosed or referred to in U.S. Pat. No. 5,807,627, PCT/WO90/13148 and PCT/WO92/03490.

The preferred conjugated polymers are poly(p-phenylenevinylene)-PPV and copolymers including PPV. Other preferred polymers are poly(2,5 dialkoxyphenylene vinylene) such as poly(2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) with at least one of the alkoxy groups being a long chain solubilising alkoxy group, poly fluorenes and oligofluorenes, polyphenylenes and oligophenylenes, polyanthracenes and oligo anthracenes, polythiophenes, oligothiophenes and poly(ethylenedioxide thiophene) (PEDOT).

In PPV the phenylene ring may optionally carry one or more substituents, e.g. each independently selected from alkyl, preferably methyl, alkoxy, preferably methoxy or ethoxy.

Any poly(arylenevinylene) including substituted derivatives thereof can be used and the phenylene ring in poly(p-phenylenevinylene) may be replaced by a fused ring system such as an anthracene or naphthlyene ring and the number of vinylene groups in each polyphenylenevinylene moiety can be increased, e.g. up to 7 or higher.

The conjugated polymers can be made by the methods disclosed in U.S. Pat. No. 5,807,627, PCT/WO90/13148 and PCT/WO92/03490.

The thickness of the hole transporting layer is preferably 20 nm to 200 nm.

The polymers of an amino substituted aromatic compound such as polyanilines referred to above can also be used as buffer layers with or in conjunction with other hole transporting materials.

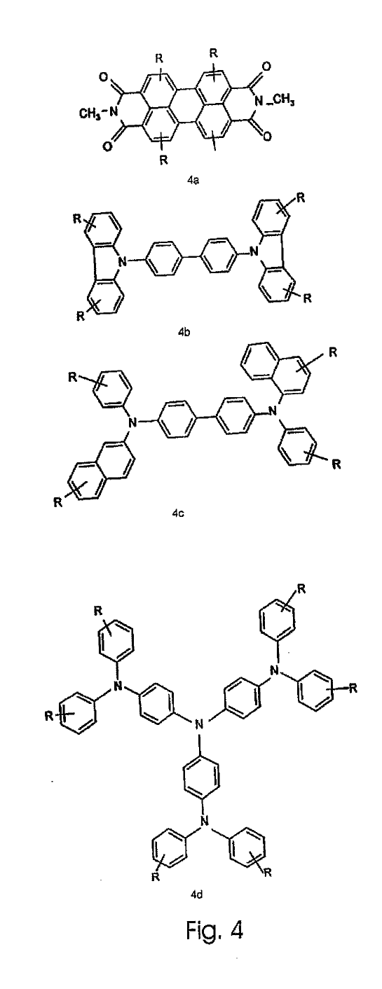

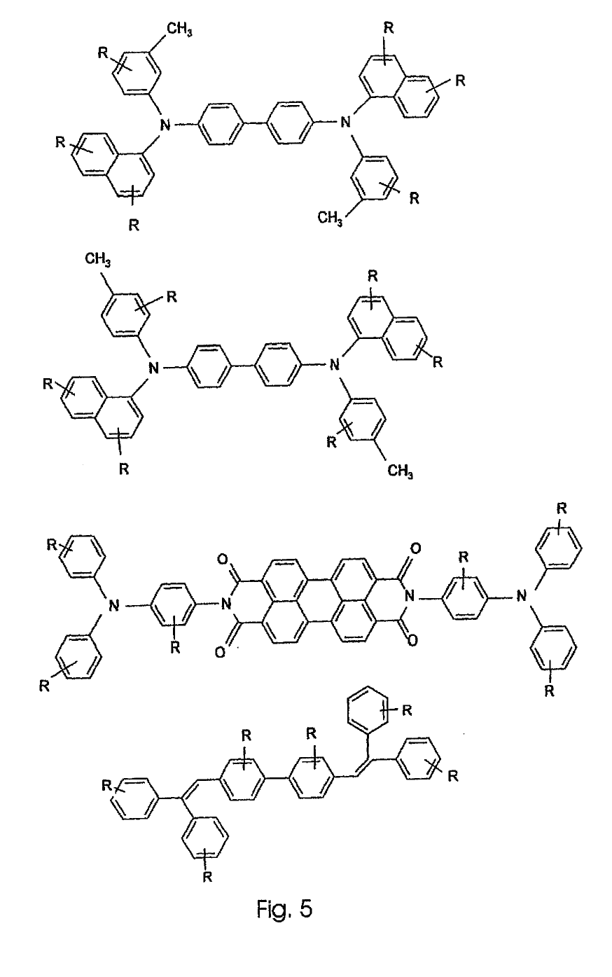

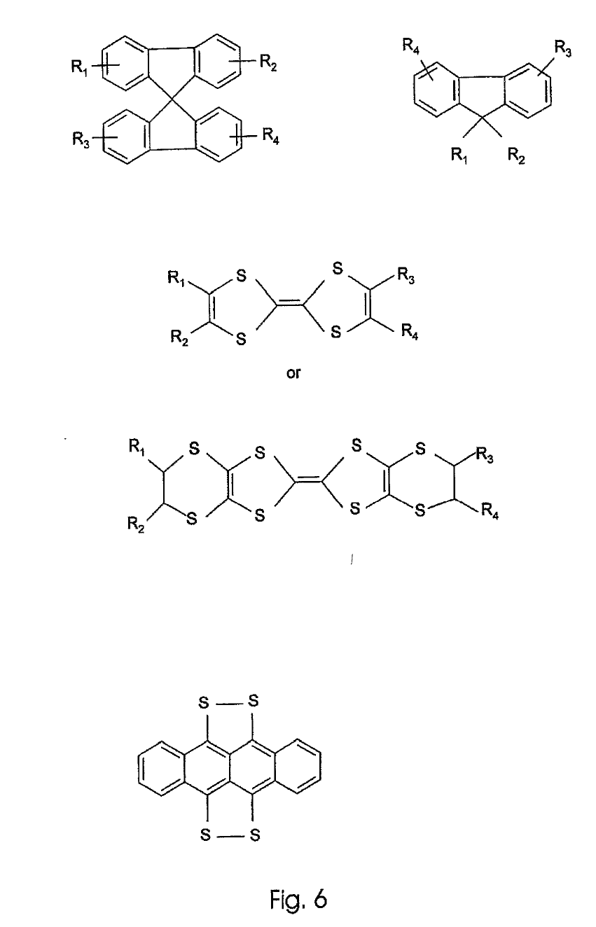

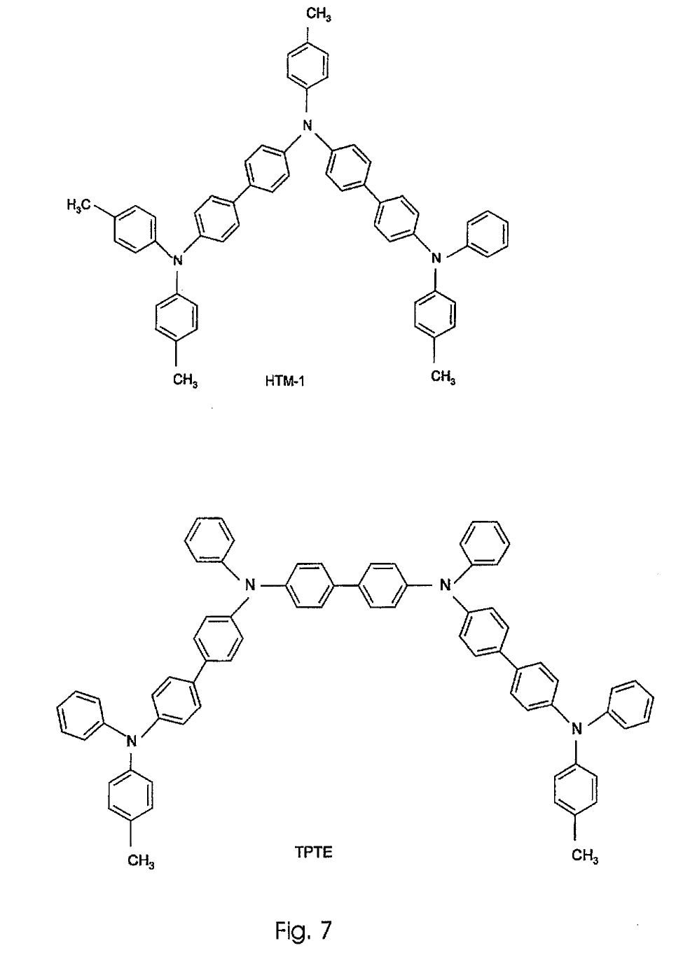

The structural formulae of some other hole transporting materials are shown in FIGS. 4, 5, 6, 7 and 8 of the drawings, where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

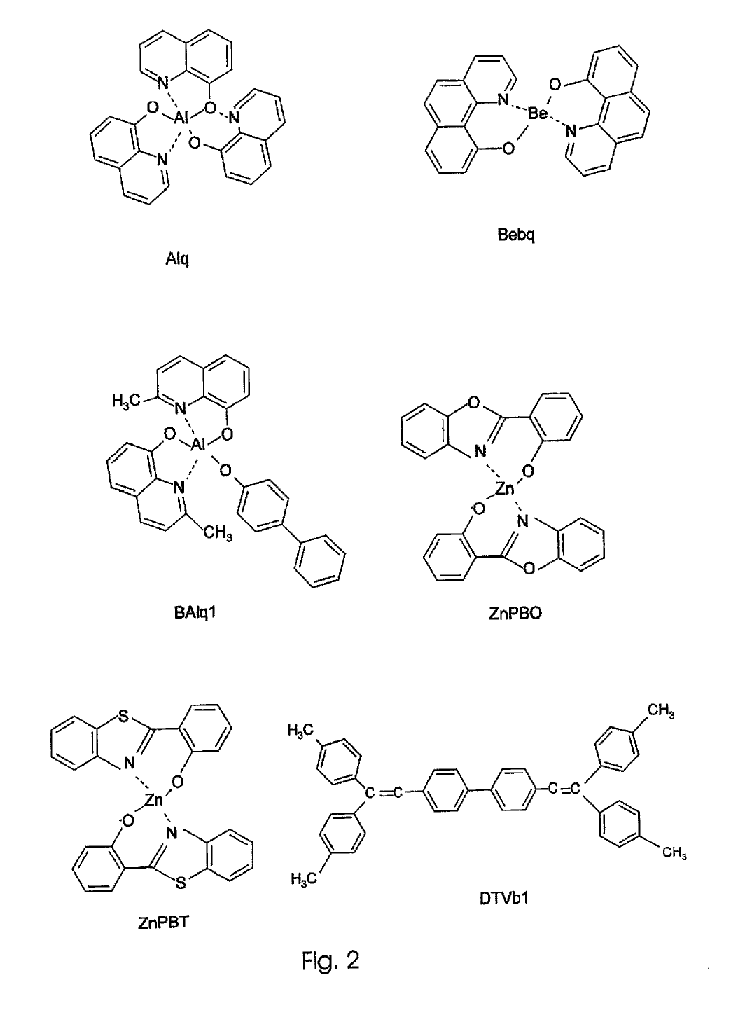

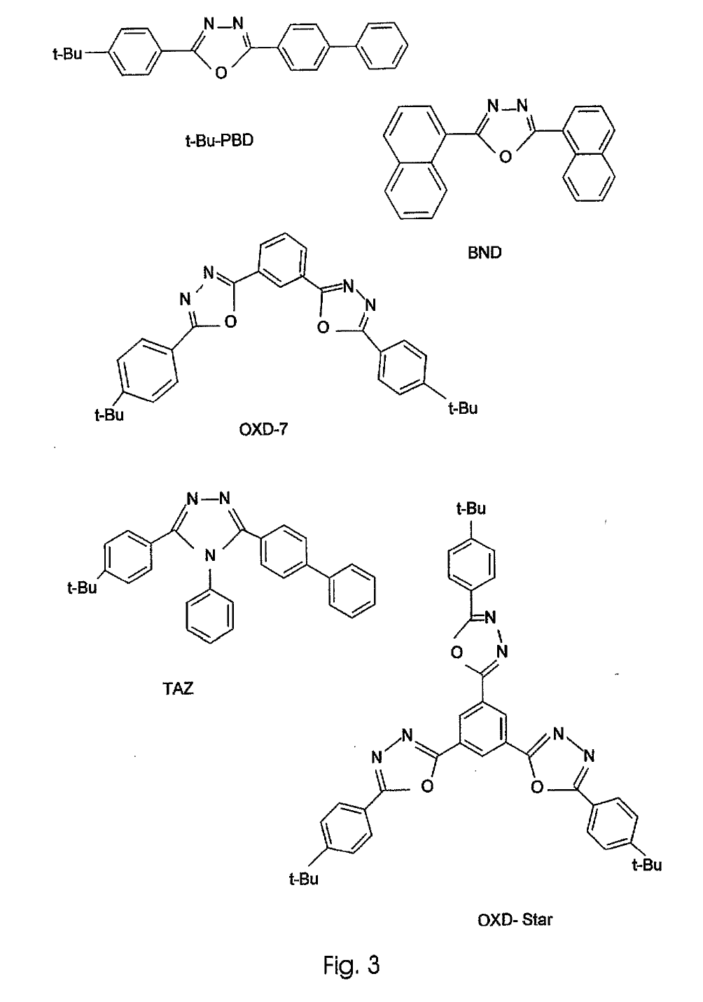

Optionally there is a layer of an electron injecting material between the anode and the electroluminescent material layer. The electron injecting material, which material will transport electrons when an electric current is passed through electron injecting materials, include a metal complex such as a metal quinolate, e.g. an aluminium quinolate, lithium quinolate, zirconium quinolate, a cyano anthracene such as 9,10 dicyano anthracene, cyano substituted aromatic compounds, tetracyanoquinidodimethane a polystyrene sulphonate or a compound with the structural formulae shown in FIG. 2 or 3 of the drawings in which the phenyl rings can be substituted with substituents R as defined above.

The electron injecting material layer should have a thickness so that the holes form the anode and the electrons from the cathode combine in the thioxinate layer.

The metal thioxinates of the present invention can also be used as an electron injecting or transmitting layer and the thickness of the layer normally les than the thickness of the electroluminescent layer so that the electrons from the cathode and holes from the anode combine in the electroluminescent layer.

In electroluminescent devices where the metal thioxinates of the present invention are used as an electron injecting or transmitting layer the device will have the structure (i) an anode (ii) a layer of an electroluminescent material, (iii) a layer of the metal thioxinate and (iv) a cathode.

Optionally there is a layer of a hole transporting material between the anode and the layer of the electroluminescent material.

The electroluminescent material can be any of the known electroluminescent materials including, without limitation, those described above.

The first electrode is preferably a transparent substrate such as a conductive glass or plastic material which acts as the anode; preferred substrates are conductive glass such as indium tin oxide coated glass, but any glass which is conductive or has a conductive layer such as a metal or conductive polymer can be used. Conductive polymers and conductive polymer coated glass or plastics materials can also be used as the substrate.

The cathode is preferably a low work function metal, e.g. aluminium, calcium, lithium, silver/magnesium alloys, rare earth metal alloys etc; aluminium is a preferred metal. A metal fluoride such as an alkali metal, rare earth metal or their alloys can be used as the second electrode, for example by having a metal fluoride layer formed on a metal.

The metal thioxinate can act as a host material electroluminescent compound and is doped with a minor amount of a fluorescent material as a dopant preferably in an amount of 5 to 15% of the doped mixture.

As discussed in U.S. Pat. No. 4,769,292, the contents of which are included by reference, the presence of the fluorescent material permits a choice from among a wide latitude of wavelengths of light emission.

By blending with the metal thioxinate a minor amount of a fluorescent material capable of emitting light in response to hole-electron recombination the hue light emitted from the luminescent zone can be modified. In theory, if a metal thioxinate and a fluorescent material could be found for blending which have exactly the same affinity for hole-electron recombination each material should emit light upon injection of holes and electrons in the luminescent zone. The perceived hue of light emission would be the visual integration of both emissions.

Since imposing such a balance of the metal thioxinate and fluorescent materials is highly limiting, it is preferred to choose the fluorescent material so that it provides the favoured sites for light emission. When only a small proportion of fluorescent material providing favoured sites for light emission is present, peak intensity wavelength emissions typical of the metal thioxinate can be entirely eliminated in favour of a new peak intensity wavelength emission attributable to the fluorescent material. While the minimum proportion of fluorescent material sufficient to achieve this effect varies by the specific choice of metal thioxinate and fluorescent materials, in no instance is it necessary to employ more than about 10 mole percent fluorescent material, based on moles of metal thioxinate and seldom is it necessary to employ more than 1 mole percent of the fluorescent material. On the other hand, for any metal thioxinate capable of emitting light in the absence of fluorescent material, limiting the fluorescent material present to extremely small amounts, typically less than about 10⁻³ mole percent, based on metal thioxinate, can result in retaining emission at wavelengths characteristic of the metal thioxinate. Thus, by choosing the proportion of a fluorescent material capable of providing favoured sites for light emission, either a full or partial shifting of emission wavelengths can be realized. This allows the spectral emissions of the EL devices of this invention to be selected and balanced to suit the application to be served.

Choosing fluorescent materials capable of providing favoured sites for light emission necessarily involves relating the properties of the fluorescent material to those of the metal thioxinate. The metal thioxinate can be viewed as a collector for injected holes and electrons with the fluorescent material providing the molecular sites for light emission. One important relationship for choosing a fluorescent material capable of modifying the hue of light emission when present in a metal thioxinate is a comparison of the reduction potentials of the two materials. The fluorescent materials demonstrated to shift the wavelength of light emission have exhibited a less negative reduction potential than that of the metal thioxinate. Reduction potentials, measured in electron volts, have been widely reported in the literature along with varied techniques for their measurement. Since it is a comparison of reduction potentials rather than their absolute values which is desired, it is apparent that any accepted technique for reduction potential measurement can be employed, provided both the fluorescent and metal thioxinate reduction potentials are similarly measured. A preferred oxidation and reduction potential measurement techniques is reported by R. J. Cox, Photographic Sensitivity, Academic Press, 1973, Chapter 15.

A second important relationship for choosing a fluorescent material capable of modifying the hue of light emission when present in a metal thioxinate is a comparison of the bandgap potentials of the two materials. The fluorescent materials demonstrated to shift the wavelength of light emission have exhibited a lower bandgap potential than that of the metal thioxinate. The bandgap potential of a molecule is taken as the potential difference in electron volts (eV) separating its ground state and first singlet state. Bandgap potentials and techniques for their measurement have been widely reported in the literature. The bandgap potentials herein reported are those measured in electron volts (eV) at an absorption wavelength which is bathochiromic to the absorption peak and of a magnitude one tenth that of the magnitude of the absorption peak. Since it is a comparison of bandgap potentials rather than their absolute values which is desired, it is apparent that any accepted technique for bandgap measurement can be employed, provided both the fluorescent and metal thioxinate band gaps are similarly measured. One illustrative measurement technique is disclosed by F. Gutman and L. E. Lyons, Organic Semiconductors, Wiley, 1967, Chapter 5.

Where a metal thioxinate is chosen which is itself capable of emitting light in the absence of the fluorescent material, it has been observed that suppression of light emission at the wavelengths of emission characteristics of the metal thioxinate alone and enhancement of emission at wavelengths characteristic of the fluorescent material occurs when spectral coupling of the metal thioxinate and fluorescent material is achieved. By spectral coupling it is meant that an overlap exists between the wavelengths of emission characteristic of the metal thioxinate alone and the wavelengths of light absorption of the fluorescent material in the absence of the metal thioxinate. Optimal spectral coupling occurs when the m ±25 nm the maximum absorption of the fluorescent material alone. In practice advantageous spectral coupling can occur with peak emission and absorption wavelengths differing by up to 100 nm or more, depending on the width of the peaks and their hypsochromic and bathochromic slopes. Where less than optimum spectral coupling between the metal thioxinate and fluorescent materials is contemplated, a bathochromic as compared to a hypsochromic displacement of the fluorescent material produces more efficient results.

Although the foregoing discussion has been undertaken by reference to metal thioxinate which are known to themselves emit light in response to hole and electron injection, in fact light emission by the metal thioxinate itself can entirely cease where light emission by the fluorescent material is favoured by any one or combination of the various relationships noted above. It is appreciated that shifting the role of light emission to the fluorescent material allows a still broader range of choices of metal thioxinates. For example, one fundamental requirement of a material chosen to emit light is that it must exhibit a low extinction coefficient for light of the wavelength it emits to avoid internal absorption. The present invention permits use of metal thioxinates which are capable of sustaining the injection of holes and electrons, but are themselves incapable of efficiently emitting light.

Useful fluorescent materials are those capable of being blended with the metal thioxinate and fabricated into thin films satisfying the thickness ranges described above forming the luminescent zones of the EL devices of this invention. While crystalline metal thioxinates do not lend themselves to thin film formation, the limited amounts of fluorescent materials present in the metal thioxinate materials permits the use of fluorescent materials which are alone incapable of thin film formation. Preferred fluorescent materials are those which form a common phase with the metal thioxinate material. Fluorescent dyes constitute a preferred class of fluorescent materials, since dyes lend themselves to molecular level distribution in the metal thioxinate. Although any convenient technique for dispersing the fluorescent dyes in the metal thioxinates can be undertaken, preferred fluorescent dyes are those which can be vacuum vapour deposited along with the metal thioxinate materials. Assuming other criteria, noted above, are satisfied, fluorescent laser dyes are recognized to be particularly useful fluorescent materials for use in the organic EL devices of this invention.

Other dopants include phosphorescent dopants such as iridium, rhodium, platinum and osmium compounds and compounds such as In(qS)₃ where qS is thioxinate.

Dopants which can be used include diphenylacridone, dimethylquinacridone, diphenylquinacridone, rubrene, coumarins, perylene and their derivatives.

Useful fluorescent dopants are disclosed in U.S. Pat. No. 4,769,292 the contents of which are included by reference.

The preferred dopants are coumarins such as those of formula 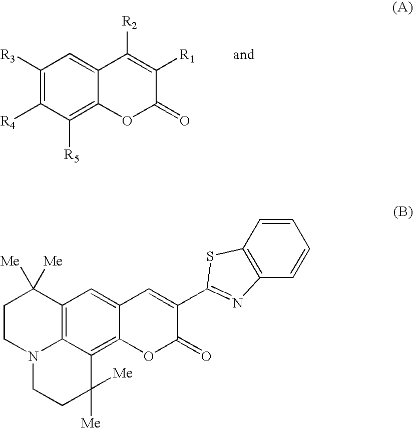
where R₁ is chosen from the group consisting of hydrogen, carboxy, alkanoyl, alkoxycarbonyl, cyano, aryl, and a heterocyclic aromatic group, R₂ is chosen from the group consisting of hydrogen, alkyl, haloalkyl, carboxy, alkanoyl, and alkoxycarbonyl, R₃ is chosen from the group consisting of hydrogen and alkyl, R₄ is an amino group, and R₅ is hydrogen, or R₁ or R₂ together form a fused carbocyclic ring, and/or the amino group forming R⁴ completes with at least one of R⁴ and R⁶ a fused ring.

The alkyl moieties in each instance contain from 1 to 5 carbon atoms, preferably 1 to 3 carbon atoms. The aryl moieties are preferably phenyl groups. The fused carbocyclic rings are preferably five, six or seven membered rings. The heterocyclic aromatic groups contain 5 or 6 membered heterocyclic rings containing carbon atoms and one or two heteroatoms chosen from the group consisting of oxygen, sulphur, and nitrogen. The amino group can be a primary, secondary, or tertiary amino group. When the amino nitrogen completes a fused ring with an adjacent substituent, the ring is preferably a five or six membered ring. For example, R⁴ can take the form of a pyran ring when the nitrogen atom forms a single ring with one adjacent substituent (R³ or R⁵) or a julolidine ring (including the fused benzo ring of the coumarin) when the nitrogen atom forms rings with both adjacent substituents R₃ and R₅.

The following are illustrative fluorescent coumarin dyes known to be useful as laser dyes: FD-1 7-Diethylamino-4-methylcoumarin, FD-2 4,6-Dimethyl-7-ethylaminocoumarin, FD-3 4-Methylumbelliferone, FD-4 3-(2′-Benzothiazolyl)-7-diethylaminocoumarin, FD-5 3-(2′-Benzimidazolyl)-7-N,N-diethylaminocoumarin, FD-6 7-Amino-3-phenylcoumarin, FD-7 3-(2′-N-Methylbenzimidazolyl)-7-N,Ndiethylaminocoumarin, FD-8 7-Diethylamino-4-trifluoromethylcoumarin, FD-9 2,3,5,6-1H,4H-Tetrahydro-8-methylquinolazino[9,9a,1-gh]coumarin, FD-10 Cyclopenta[c]julolindino[9,10⁻³]-11H-pyran-11-one, FD-11 7-Amino-4-methylcoumarin, FD-12 7-Dimethylaminocyclopenta[c]coumarin, FD-13 7-Amino-4-trifluoromethylcoumarin, FD-14 7-Dimethylamino-4-trifluoromethylcoumarin, FD-1,2,4,5,3H,6H,10H-Tetrahydro-8-trifluoromethyl[1]benzopyrano[9,9a,1-gh]quinolizin-10-one, FD-16 4-Methyl-7-(sulfomethylamino)coumarin sodium salt, FD-17 7-Ethylamino-6-methyl-4-trifluoromethylcoumarin, FD-18 7-Dimethylamino-4-methylcoumarin, FD-19 1,2,4,5,3H,6H, 10H-Tetrahydro-carbethoxy[1]benzopyrano[9,9a,1-gh]quinolizino-10-one, FD-20 9-Acetyl-1,2,4,5,3H,6H,10H-tetrahydro[1]benzopyrano[9,9a,1-gh]quinolizino-10-one, FD-21 9-Cyano-1,2,4,5,3H,6H,10H-tetrahydro[1]benzopyrano[9,9a,1-gh]quinolizino-10-one, FD22 9-(t-Butoxycarbonyl)-1,2,4,5,3H,6H,10H-tetrahyro[1]benzopyrano[9,9a,1-gh]quinolizino-10-one, FD-23 4-Methylpiperidino[3,2-g]coumarin, FD-24 4-Trifluoromethylpiperidino[3,2-g]coumarin, FD-25 9-Carboxy-1,2,4,5,3H,6H,10H-tetrahydro[1]benzopyrano[9,9a,1-gh]quinolizino-10-one, FD-26 N-Ethyl-4-trifluoromethylpiperidino[3,2-g].

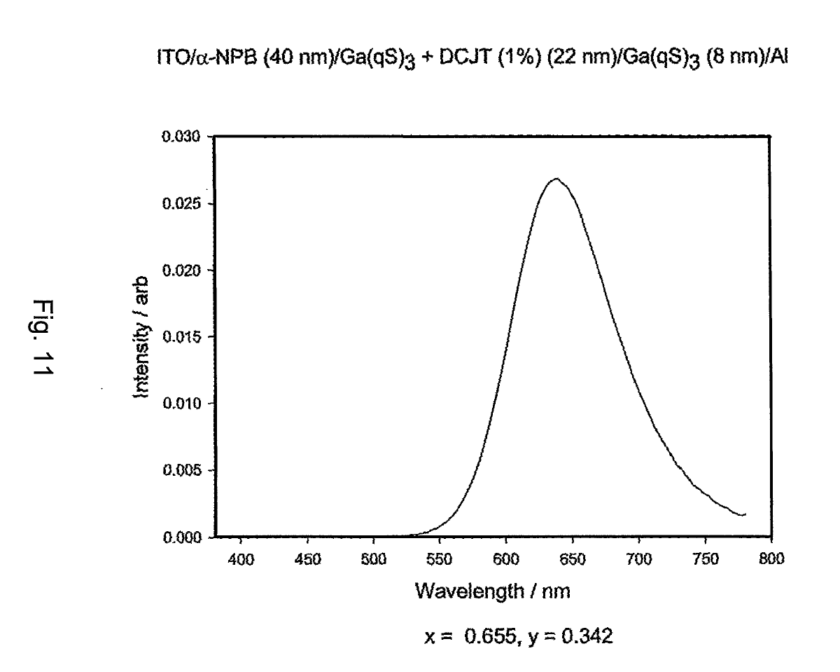

Other dopants include salts of bis benzene sulphonic acid such as 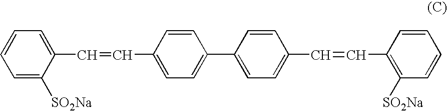
and perylene and perylene derivatives and dopants of the formulae of FIGS. 11 to 13 of the drawings where R₁, R₂, R₃ and R₄ are R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated alkylene groups such as vinyl groups or groups
—C—CH₂═CH₂—R
where R is as above.

Other dopants are dyes such as the fluorescent 4-dicyanomethylene-4H-pyrans and 4-dicyanomethylene-4H-thiopyrans, e.g. the fluorescent dicyanomethylenepyran and thiopyran dyes.

Useful fluorescent dyes can also be selected from among known polymethine dyes, which include the cyanines, merocyanines, complex cyanines and merocyanines (i.e., tri-, tetra- and poly-nuclear cyanines and merocyanines), rhodamine, oxonols, hemioxonols, styryls, merostyryls, and streptocyanines and compounds of formula 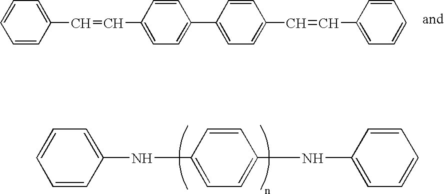
and their derivatives, where n is 1-3.

The cyanine dyes include, joined by a methine linkage, two basic heterocyclic nuclei, such as azolium or azinium nuclei, for example, those derived from pyridinium, quinolinium, isoquinolinium, oxazolium, thiazolium, selenazolium, indazolium, pyrazolium, pyrrolium, indolium, 3H-indolium, imidazolium, oxadiazolium, thiadioxazolium, benzoxazolium, benzothiazolium, benzoselenazolium, benzotellurazolium, benzimidazolium, 3H- or 1H-benzoindolium, naphthoxazolium, naphthothiazolium, naphthoselenazolium, naphthotellurazolium, carbazolium, pyrrolopyridinium, phenanthrothiazolium, and acenaphthothiazolium quaternary salts.

Other useful classes of fluorescent dyes are 4-oxo-4H-benz-[d,e]anthracenes and pyrylium, thiapyrylium, selenapyrylium, and telluropyrylium dyes.

Further dopants are compounds of formula 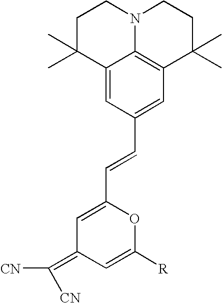
where R is H or a C1-4 alkyl group; when R is H the compound is DCJT, when R is i-Pr the compound is DCJTI and when R is t-Bu the compound is DCJTB.

There can be more than one dopant used and there can be different layers with different dopants.

The invention is illustrated in the examples below in which examples 1 to 3 are for the synthesis of thioxinates and examples 4 to 8 are examples of devices using these thioxinates.

### EXAMPLE 1—GALLIUM THIOXINATE

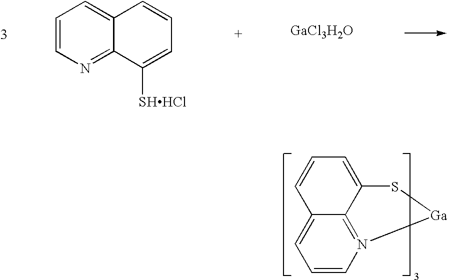

Piperidine (0.3 mL) was added dropwise to a solution of gallium (III) chloride (1.5 mL 0.28M solution in ethanol, 0.42 mmol) and 8-quinolmethiol hydrochloride (0.25 g, 1.26 mmol) in ethanol (95%, 30 mL). An immediate yellow precipitate formed and the reaction was stirred at ambient temperature for 1 hour. After this time the solid was isolated on a Buchner funnel and washed with further ethanol (3×50 mL), dried in vacuo and further purified by entrainment sublimation (290° C., 10⁻⁷ Torr). Yield 0.17 g (75%). M.p. 272° C., Tg 109° C. Elemental analysis (pre-sublimed sample): calc. C 58.92, H 3.30, N 7.64; Found C, 57.92; H, 3.27; N, 7.15.

### EXAMPLE 2—INDIUM THIOXINATE

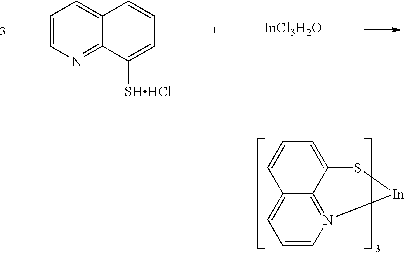

Piperidine (0.3 mL) was added dropwise to a solution of indium (III) chloride (0.067 g, 0.30 mmol) and 8-quinolinethiol hydrochloride (0.18 g, 0.90 mmol) in ethanol (95%, 30 mL). An immediate yellow precipitate formed and the reaction was stirred at ambient temperature for 1 hour. After this time the solid was isolated on a Buchner funnel and washed with further ethanol (3×50 mL) and dried in vacuo. The sample may be further purified by entrainment sublimation. Yield 0.13 g (70%). M.p. 334° C., Tg 137° C.

### EXAMPLE 3—ZINC THIOXINATE

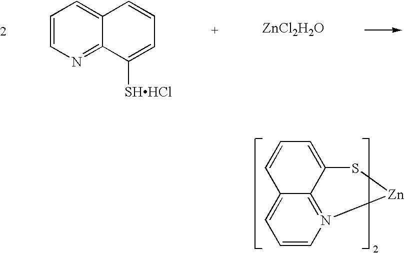

Piperidine (0.6 mL) was added dropwise to a solution of zinc (II) chloride hydrate (0.17 g, 1.25 mmol) and 8-quinolinethiol hydrochloride (0.50 g, 2.53 mmol) in ethanol (95%, 25 mL). An immediate yellow precipitate formed and the reaction was stirred at ambient temperature for 1 hour. After this time the solid was isolated on a Buchner funnel and washed with further ethanol (3×50 mL) and dried in vacuo. The sample may be further purified by entrainment sublimation. Yield 0.31 g (62%). M.p. 291.9° C.

### EXAMPLE 4—DEVICE 1

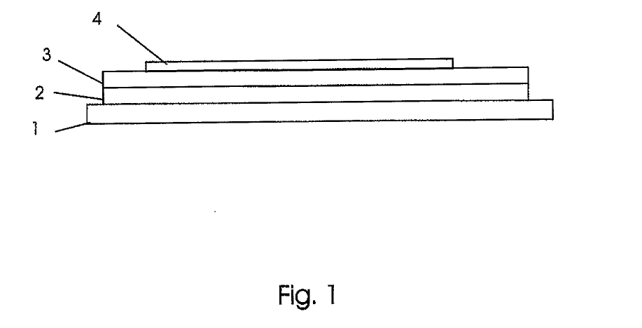

A device of structure shown in FIG. 1 was fabricated by a method in which a pre-etched ITO coated glass piece (10×10 cm²) was used. The device was fabricated by sequentially forming on the ITO, by vacuum evaporation using a Solciet Machine,

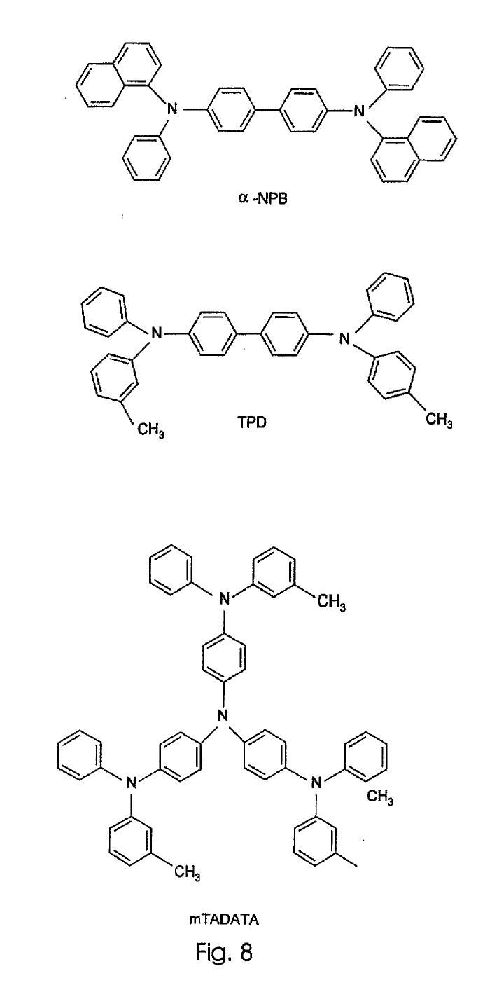

ULVAC Ltd. Chigacki, Japan; the active area of each pixel was 3 mm by 3 mm, the layers comprised:—
(1)ITO(2)α-NPB(40 nm)/(3)Ga(qS)₃(30 nm)/(4)Al
where α-NPB is as in FIG. 8 and Ga(qS)₃ is gallium thioxinate synthesised as in Example 1.

The coated electrodes were stored in a vacuum desiccator over a molecular sieve and phosphorous pentoxide until they were loaded into a vacuum coater (Edwards, 10⁻⁶ torr) and aluminium top contacts made. The devices were then kept in a vacuum desiccator until the electroluminescence studies were performed.

The ITO electrode was always connected to the positive terminal. The current vs. voltage studies were carried out on a computer controlled Keithly 2400 source meter.

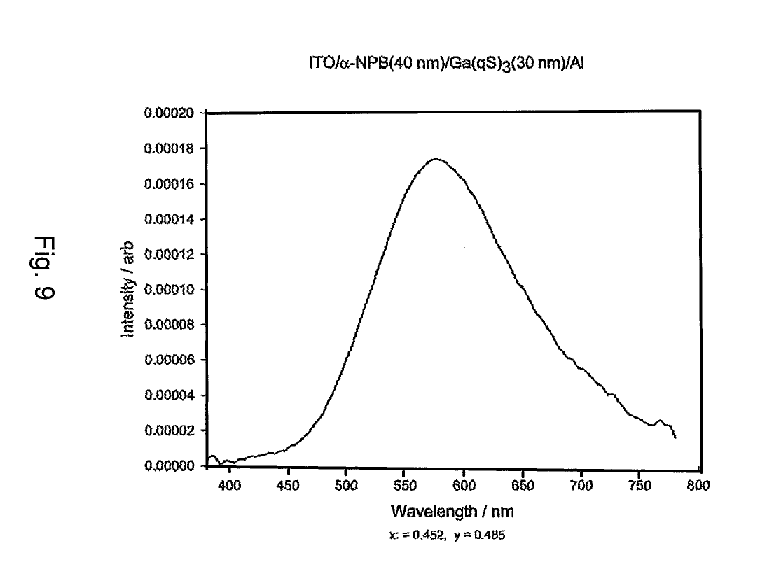

The electroluminescent properties were measured and the spectrum is shown in FIG. 9.

### EXAMPLE 5—DEVICE 2

A device was constructed as in Example 4 with the structure
(1)ITO/(2)α-NPB(40 nm)/(3)Ga(qS)₃+DCJT(1%)/(22 nm)/(4) Ga(qS)₃(8=m)/(5)Al
where DCJT is

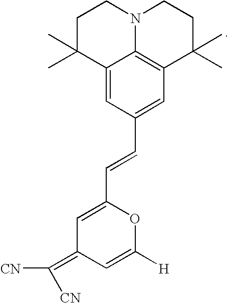

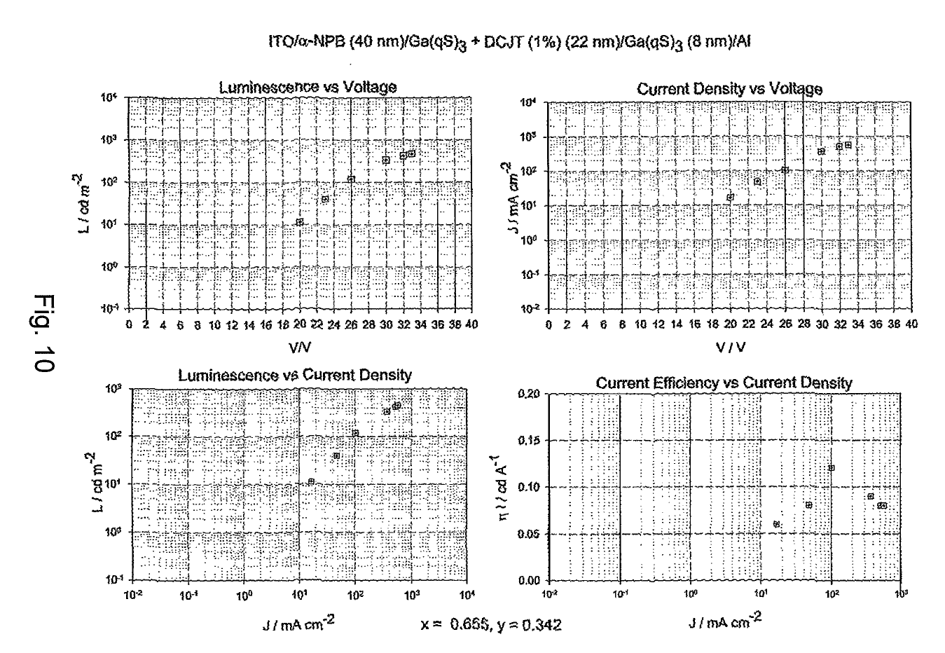

The spectrum and electroluminescent properties are shown in FIGS. 10 and 11.

### EXAMPLE 6—DEVICE 3

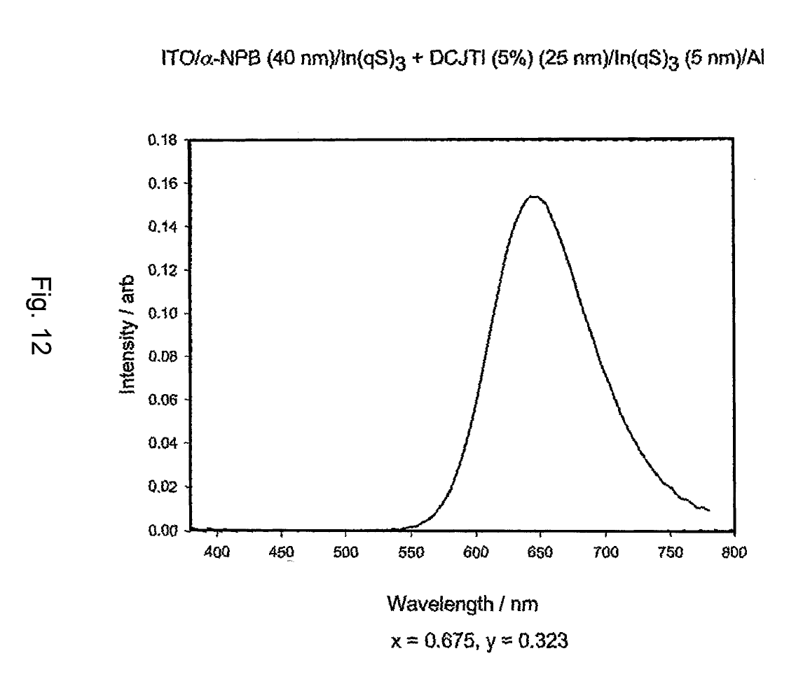

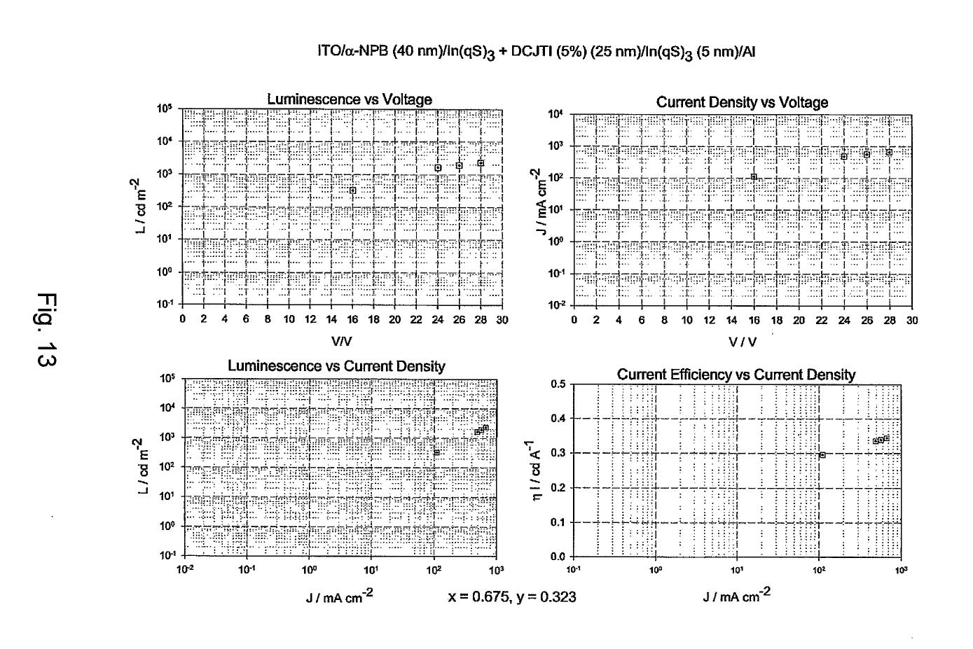

A device was constructed as in Example 4 with the structure
(1)ITO/(2)α-NPB(40 nm)/(3)In(qS)₃+DCJTI(5%)/(25 nm)/(4) In(qS)₃(5 nm)/(5)Al
Where is as described in the specification. The spectrum and electroluminescent properties are shown in FIGS. 12 and 13.

### EXAMPLE 7—DEVICE 4

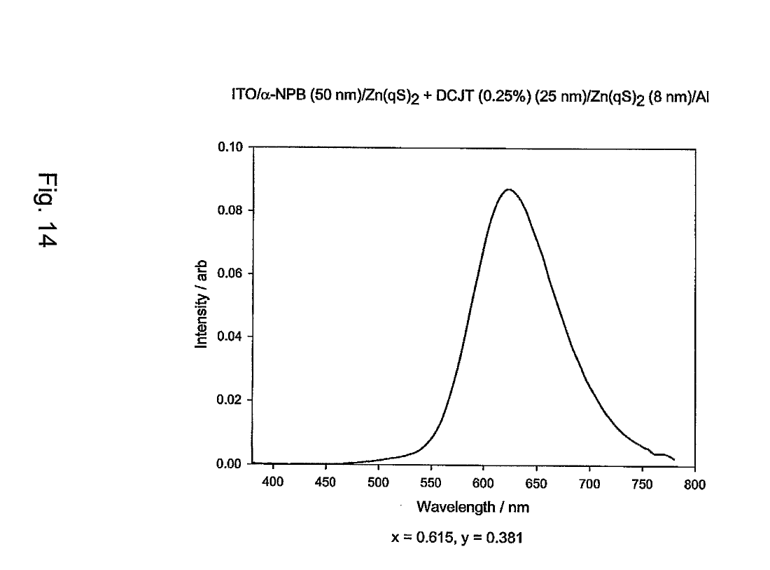

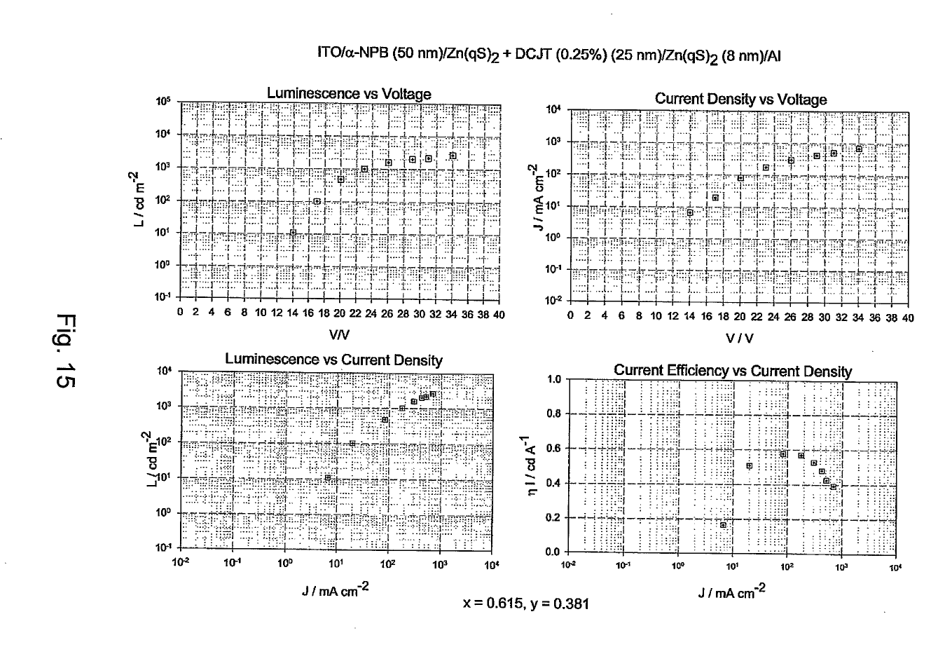

A device was constructed as in Example 4 with the structure
(1)ITO/(2)α-NPB(50 nm)/(3)Zn(qS)₂+DCJT(0.25%)(25 nm)/Zn(qS)₂(8 nm)/(4)Al
The spectrum and electroluminescent properties are shown in FIGS. 14 and 15.

### EXAMPLE 8—DEVICE 5

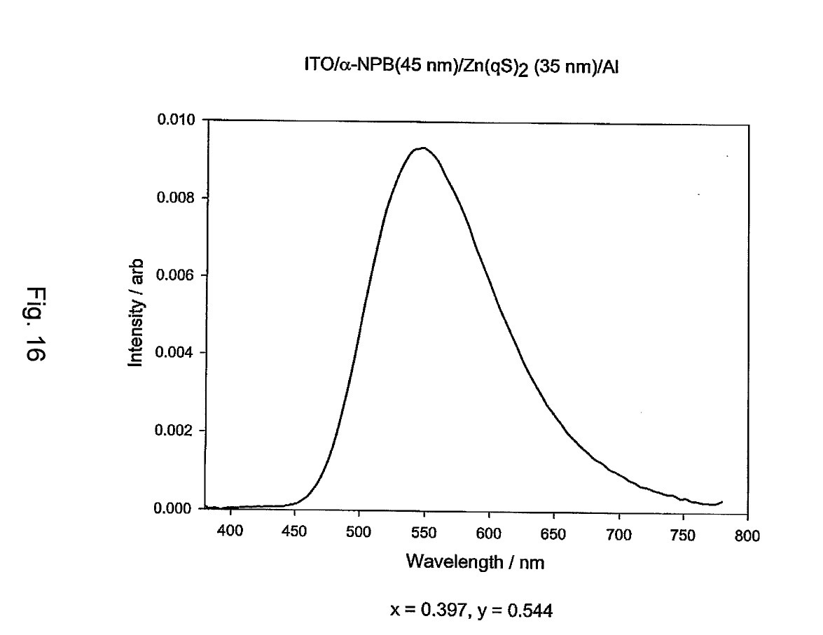

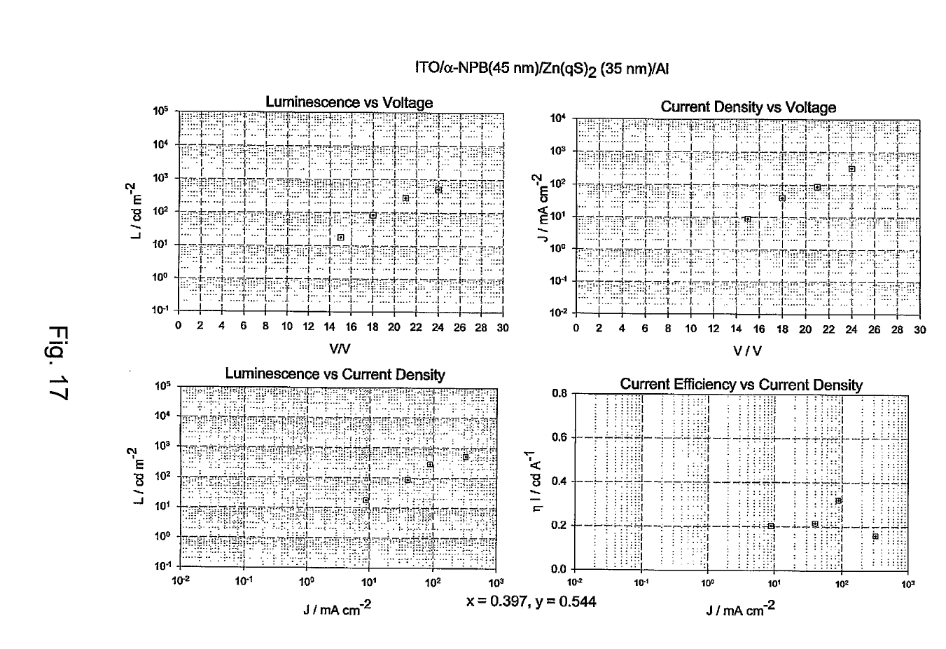

A device was constructed as in Example 4 with the structure
(1)ITO/(2)α-NPB (40 nm)/(3)Zn(qS)₂(35 nm)/(4)Al
The spectrum and electroluminescent properties are shown in FIGS. 16 and 17.

1-37. (canceled)

38. An electroluminescent compound of formula 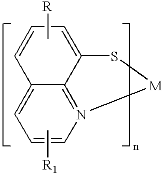
where M is a metal;
n is the valence of M;
R and R₁ which can be the same or different are selected from hydrogen,
substituted and unsubstituted hydrocarbyl groups such as substituted and unsubstituted aliphatic groups, substituted and unsubstituted aromatic, heterocyclic and polycyclic ring structures,
fluorocarbons such as trifluomethyl groups,
halogens such as fluorine;
thiophenyl groups; and
cyano.

39. The compound of claim 38, wherein R and/or R₁ are selected from
aliphatic, aromatic and heterocyclic groups,
alkoxy, aryloxy and carboxy groups,
substituted and substituted phenyl, fluorophenyl, biphenyl, phenanthrene, anthracene, naphthyl and fluorene groups,
alkyl groups such as t-butyl and
heterocyclic groups such as carbazole.

40. The compound of claim 38, wherein the metal M is selected from lithium, sodium, potassium, rubidium, cesium, beryllium, magnesium, calcium, strontium, barium, copper, silver, gold, zinc, cadmium, boron, aluminum, gallium, indium, germanium, tin (II), tin (IV), antimony (II), antimony (IV), lead (II), lead (IV) and metals of the first, second and third groups of transition metals in different valence states, manganese, iron, ruthenium, osmium, cobalt, nickel, palladium(II), palladium(IV), platinum(II), platinum(IV), cadmium, chromium. titanium, vanadium, zirconium, tantalum, molybdenum, rhodium, iridium, titanium, niobium, scandium and yttrium.

41. The compound of claim 38, wherein the metal M is zinc, cadmium, gallium or indium.

42. An electroluminescent composition which consists essentially of the electroluminescent compound of claim 38 mixed with an effective amount of a fluorescent or phosphorescent dopant.

43. The composition of claim 42, wherein the dopant is selected from
(a) diphenylacridone, dimethylquinacridone, diphenylquinacridone, rubrene, coumarins, perylene, derivatives quinolates, porphoryin, porphines, pyrazalones and their derivatives;
(b) compounds of the formulae (A) 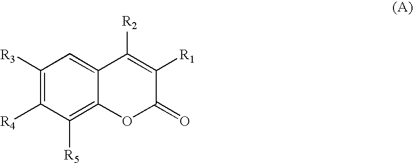
where
R₁ is chosen from the group consisting of hydrogen, carboxy, alkanoyl, alkoxycarbonyl, cyano, aryl, and a heterocyclic aromatic group,
R₂ is chosen from the group consisting of hydrogen, alkyl, haloalkyl, carboxy, alkanoyl, and alkoxycarbonyl,
R₃ is chosen from the group consisting of hydrogen and alkyl,
R₄ is an amino group, and R₅ is hydrogen, or
R₁ and R₂ together form a fused carbocyclic ring, and/or
the amino group forming R₄ completes with at least one of R₃ and R₅ to form a fused ring;
(c) the compound of formula (B) 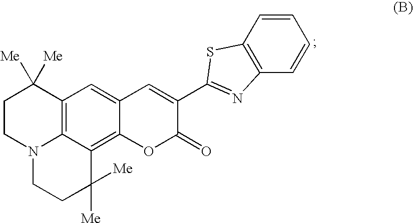
wherein Me are methyl groups;
(d) the compound of formula (C) 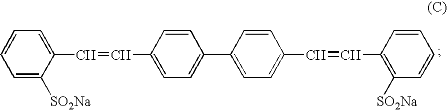
(e) a fluorescent coumain dye selected from the following:
Diethylamino-4-methylcoumarin;
4,6-Dimethyl-7-ethylaminocoumarin,
4-Methylumbelliferone;
3-(2′-Benzothiazolyl)-7-diethylaminocoumarin;
3-(2′-Benzimidazolyl)-7-N,N-diethylaminocoumarin;
7-Amino-3-phenylcoumarin,
3-(2′-N-Methylbenzimidazolyl)-7-N,Ndiethylaminocoumarin;
7-Diethylamino-4-trifluoromethylcoumarin;
2,3,5,6-1-H,4H-Tetrahydro-8-methylquinolazinocoumarin;
Cyclopenta[c]ljulolindino[9,10-3]-11H-pyran-1′-one;
7-Amino-4 methylcoumarin;
7-Dimethylaminocyclopenta[c]coumarin;
7-Amino-4-trifluoromethylcoumarin;
7-Dimethylamino-4-trifluoromethylcoumarin;
1,2,4,5,3H,6H,10H-Tetrahydro-8-trifluoromethyl-[9,9a,1gh]-quinolizino-10-one;
4-Methyl-7-(sulfomethylamino)-coumarin sodium salt;
7-Ethylamino-6-methyl-4-trifluoromethylcoumarin;
7-Dimethylamino-4-methylcoumarin;
1,2,4,5,3H,6H, 10HTetrahydrocarbethoxy[1]benzopyrano[9,9a,1-gh]quinolizino-10-one,
9-Acetyl-1,2,4,5,3H,6H,10H-tetrahydro[1]benzopyrano[9,9a,1-gh]-quinolizino-10-one;
9Cyano-1,2,4,5,3H,6H,10H-tetrahydro[1]benzopyrano[9,9a,1-gh]quinolizino-10-one;
9-(t-Butoxycarbonyl)-1,2,4,5,3H,6H,10H-tetrahydro[1]benzopyrano [9,9a,1-gh]quinolizino-10-one;
4-Methylpiperidino[3,2-g]coumarin;
4,2,0-Trifluoromethylpiperidino[3,2-g]coumarin;
9-Carboxy-1,2,4,5,3H,6H,10H-tetrahydro[1]benzopyrano[9,9a,1-gh]quinolizino-10-one; and
N-Ethyl-4 trifluoromethylpiperidino[3,2-g]; and
(f) a compound of the formula 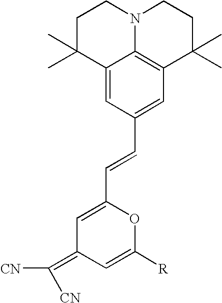
where R is H, C₁-C₄ alkyl, isopropyl or t-butyl.

44. The composition of claim 42, in which there is up to 10 mole % fluorescent material, based on moles of organo metallic complex.

45. The composition of claim 42, in which there is up to 1 mole percent fluorescent material, based on moles of organo metallic complex.

46. Sew) The composition of claim 42, in which there is less than 10⁻³ mole percent fluorescent material, based on moles of organo metallic complex.

47. An electroluminescent device which comprises (i) a first electrode, (ii) a second electrode, and (iii) a layer of an electroluminescent compound as claimed in claim 38 located between said first and second electrodes.

48. The device of claim 47, in which there is a layer of a hole transmitting material between the first electrode and the electroluminescent layer.

49. The device of claim 48, in which the hole transmitting material is an aromatic amine complex.

50. The device of claim 49 in which the hole transmitting material is selected from
(a) a polyaromatic amine;
(b) a film of a polymer selected from poly(vinylcarbazole), N,N′ diphenyl-N,N′-bis(3-methylphenyl)-1,1′-biphenyl 4,4′-diamine (TPD), polyaniline, substituted polyanilines, polythiophenes, substituted polythiophenes, polysilanes and substituted polysilanes;
(c) a film of a compound of formula (VI) or (VII) herein or as in FIGS. 4 to 8 of the drawings;
(d) a copolymer of aniline, a copolymer of aniline with o anisidine, m-sulphanilic acid or o-aminophenol, or o-toluidine with o-aminophenol, o-ethylaniline, o-phenylene diamine or with an amino anthracene; and,
(e) a conjugated polymer selected from poly(p-phenylenevinylene)-PPV and copolymers such as PPV, poly(2,5 dialkoxyphenylene vinylene), poly(2-methoxy-5-(2 methoxypentyloxy-1,4-phenylene vinylene), poly(2-methoxypentyloxy)-1,4 phenylenevinylene), poly(2-methoxy-5-(2-dodecyloxy-1,4-phenylenevinylene) and 1 other poly(2,5 dialkoxyphenylenevinylenes) with at least one of the alkoxy groups being a long chain solubilising alkoxy group, poly fluorenes and oligofluorenes,-2 7 polyphenylenes and oligophenylenes, polyanthracenes and oligo anthracenes, ploythiophenes and oligothiophenes.

51. The device of claim 47, wherein the electroluminescent compound is mixed with a hole transmitting material.

52. The device of claim 47, wherein one of said first and second electrodes is a cathode and there is a layer of an electron transmitting material between the cathode and the electroluminescent compound layer.

53. The device of claim 52, wherein the electron transmitting material is a metal quinolate or a metal thioxinate.

54. The device of claim 53, wherein the metal quinolate is an aluminium quinolate, zirconium quinolate or lithium quinolate and the metal thioxinate is indium, gallium, or zinc thioxinate.

55. The device of claim 52, wherein the electron transmitting material is of formula Ax(DBM)ₙ where Ax is a metal, DBM is dibenzoyl methane and n is the valence of Ax.

56. The device of claim 52, in which the electron transmitting material
(a) is a cyano anthracene such as 9,10 dicyano anthracene, a polystyrene sulphonate or a compound of formulae shown in FIG. 2 or 3 of the drawings or zirconium quinolate, lithium quinolate, indium, gallium, or zinc thioxinate; or
(b) is a metal thioxinate.

57. The device of claim 47 in which the electroluminescent compound is mixed with an electron transmitting material.

58. The device of claim 47 in which one of the electrodes is a transparent electricity conducting glass electrode.

59. The device of claim 47, in which one of the electrodes is selected from aluminium, calcium, lithium, magnesium and alloys thereof and silver/magnesium alloys.

60. A method of making an electroluminescent compound as claimed in claim 38 which comprises reacting a salt of the metal M with 8-quinolinethiol or a derivative thereof.

61. The method of claim 60 in which the reaction takes place in the presence of ethanol.

62. The method of claim 60, in which the salt is a chloride.
